(19) United States
(12) Patent Application Publication
(10) Pub. No.: US 2011/0127343 A1
(43) Pub. Date: Jun. 2, 2011

(54) Wirelessly controlled heating system

(76) Inventor: Steven Rimmer, Brooklyn, NY (US)

(21) Appl. No.: 12/592,762

(22) Filed: Dec. 2, 2009

(51) Int. Cl. F24D 1/02; G05D 23/00; F24D 1/00

(52) U.S. Cl. 237/9 R; 236/51; 237/81

(57) ABSTRACT

The system includes a boiler, and multiple radiators connected to the boiler via a network of pipes. It includes a central processor for monitoring and control, air vent controllers that control the flow of steam through the radiators and a boiler control which turns the boiler on and off. The radiators are divided into groups. The central controller communicates with the air vent controllers to determine the conditions in the various groups. Based at least in part on the conditions, central controller may determine that the group requires heat. If heat is required and other parameters agree, central processor determines the state of the boiler. If off, the boiler is instructed to turn on and the air vent controllers in the group are instructed to open. Each air vent controller in that heat zone will then open allowing air to flow through the radiator and heat to be provided.

### FIELD OF THE INVENTION

The invention relates generally to heating systems and methods of controlling the same and, more particularly, to steam heat systems and controls and methods for controlling various aspects of the systems.

### BACKGROUND OF THE INVENTION

A conventional steam heating system includes a boiler and various radiators connected to the boiler by one or more pipes. There are different configurations such as a single pipe system with main pipes pitched towards the boiler, single pipe systems with main pipes pitches away from the boiler, stem trap systems, etc. Each of these configurations share some of the same elements. The boiler is typically located at the bottom of the system, such as in the basement of a building, and the radiators are typically located in various locations above the boiler, such as in various rooms of an apartment. When the system is operating correctly, water in the boiler is converted to steam, the steam rises through the pipes and into the radiators, the radiators heat up and the air in the rooms in which the radiators are located heat up. When the steam in a radiator cools, it condenses to water, which drains down the pipe(s) back to the boiler where it is again available to be converted into steam. This condensation makes more room for additional steam to be added to that particular radiator thus keeping the radiator hot. This condensation also creates a vacuum in the radiator which draws additional steam to replace the condensed steam. In an effort to prevent such a vacuum in the boiler, vacuum valves may be employed on or near the boiler. Additionally, to prevent an explosion due to pressure, safety valves may also be employed.

A conventional radiator, for ease of explanation, is essentially a conduit for the steam. At one end of the conduit is the pipe leading to the boiler. Radiators typically include a manual valve at this end of the radiator for connecting the radiator to and/or disconnecting the radiator from the system. At the other end of the conduit is a vent valve which allows cool air to be released from the radiator. When the system is operating and the vent valve is open, steam enters the radiator and pushes the cold air out through the vent valve. Once the steam reaches the vent valve, the valve closes, trapping the steam within the radiator. With the steam trapped in the radiator, the radiator heats up.

The vent valve is conventionally controlled by a bi-metallic strip or some other thermal or steam responsive strip that closes when it comes in contact with the steam. The size of the vent valve controls the rate at which a radiator is heated. A larger vent valve allows a radiator to heat quickly by quickly releasing the cool air from the radiator. A smaller vent valve forces a radiator to heat more slowly, by releasing the cooler air at a slower rate than the larger valve. Various vent sizes may be employed to meet different demands of various parts of a particular system.

While steam heat is relatively inexpensive and reliable it is not without its drawbacks. For instance, conventional steam heating systems do not discern which radiators to heat. Additionally, the heat is not evenly distributed throughout the system; i.e. those radiators closest to the boiler tend to receive more heat and receive the heat quicker than those farthest away. Further, steam heat tends to be inefficient to the extent that the boiler tends to operate at the same rate regardless of how many radiators actually need heat. These are some reasons steam heat is not typically utilized in residential houses. Instead, steam heat is typically reserved for large buildings.

Systems exist that attempt to regulate heating systems. Examples of such systems are U.S. Pat. No. 4,147,302 entitled Home Heating System Control, U.S. Pat. No. 6,454,179 entitled Method for Controlling a Heating System and a Heating System and U.S. Pat. No. 7,130,720 entitled Radio Frequency Control of Environmental Zones. However, these systems are either not related to steam heat, are not practical solutions and/or do not centralize the control of the system.

It would thus be advantageous to create steam heat systems and methods for controlling the same. It would also be advantageous to provide such systems and methods that are practical, require relatively low energy for control and which reduce energy requirements to operate the system.

### BRIEF SUMMARY OF THE INVENTION

Many advantages of the invention will be determined and are attained by the invention, which in a broadest sense provides steam heating systems and methods for controlling the same. In at least some embodiments it provides systems and methods for wirelessly controlling steam heat systems from one or more centralized locations. In at least some of the embodiments it provides latching solenoids for controlling one or more radiators. Implementations of the invention may provide one or more of the following features.

An aspect of the invention provides a system to facilitate the provision and regulation of steam heat in a building. The building may have multiple rooms, a boiler and multiple radiators. Each of the radiators is connected to the boiler via a network of pipes and there is a radiator located in many if not all of the rooms. They system includes a central processor that is configured to monitor and adjust the system. The central processor includes a central processor transceiver. The system also includes air vent controllers which include an air vent controller transceiver for wireless communication with the central processor. Each air vent controller is adapted to be attachable to a respective radiator. The air vent controllers may be selectively shifted from an open state to a closed state and visa versa. In the open state, an air vent controller allows air to flow through the air vent controller and in the closed state air is prevented from flowing through the air vent controller. The air vent controllers are separated into at least two groups. Each group will represent a heating zone in the building. The system also includes room thermometers respectively coupled at least to some of the air vent controllers. The room thermometers are configured to measure the room temperature in a room in which a radiator is located. The air vent controllers which are associated with a room thermometer are configured to communicate the room temperature and the state of the air vent controller to the central processor via the air vent controller transceiver. The central processor is configured to, at least in part in response to the communications from the air vent controllers, determine that a group of air vent controllers needs to be placed in the open state and to send an instruction to that group of air vent controllers to change to the open state. The group of air vent controllers for which the command is intended are configured to, in response to receipt of the instruction from said central processor, change to the open state.

Another aspect of the invention provides a method of providing steam heat to a building that has radiators connected to a boiler via a network of pipes. The method includes assigning identifiers to at least some of the radiators and separating the radiators into at least 2 groups using the identifiers to differentiate the groups. The method also includes configuring each of the radiators within a group to operate under a common set of parameters and monitoring the parameters at a central processor. The central processor receives communications from the radiators in the group and determines from those communications whether the group parameters indicate that the group requires heat. If the parameters indicate that the group requires heat, then the central processor determines the state of the boiler (whether the boiler is on or off). If the boiler is on then the central processor sends an instruction to the group of radiators to turn on. If the boiler is off then prior to sending the instruction to the radiators, the central processor sends an instruction to the boiler to turn on.

In another aspect of the invention a system is provided for facilitating a steam heating system. The system includes radiators, each having an inlet for steam and an outlet for air. At least some of the radiators are assigned an identifier (ID) for grouping multiple radiators together into multiple groups or zones. The system includes a source of steam (e.g. a boiler) and pipes/conduits connecting the steam source to the inlets of the radiators that have been assigned IDs. Steam from the source of steam is capable of traveling through the conduits to the inlet of each of the radiators pushing colder air through the inlet and out the outlet of each radiator until the outlets are closed. Once the outlets are closed, the steam is trapped in the radiator, the radiator heats up and heats the air in the room. Each of the radiators with an ID includes an air vent controller that is connected to the radiator at the outlet. The air vent controller automatically closes the outlet when a temperature of the radiator reaches a predetermined temperature thus preventing air to flow through said radiator. The system also includes a central processor located remote from the radiator, which is configured to wirelessly communicate with the air vent controllers in the groups of radiators. The central processor is also configured to signal the air vent controllers based on their groups to open the radiator outlets as a group based on predetermined parameters for the group. The air vent controller also includes a battery for providing pulses of electrical current to change the air vent controller from open to closed or closed to open and to provide electrical current for communicating with the central processor.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is a diagram of a conventional steam heat system;

FIG. 2 is a diagram of a steam heating system in accordance with one or more embodiments of the invention;

FIG. 3 illustrates an alternate steam heating system in accordance with one or more embodiments of the invention;

FIG. 4 illustrates an alternate embodiment of FIG. 3 which eliminates the need for separate air vents;

FIG. 5 illustrates an alternate embodiment of FIG. 2 including multiple boilers of the substantially the same capacity;

FIG. 6 illustrates an alternate embodiment of FIG. 2 including multiple boilers having different capacities;

FIG. 7 illustrates a block diagram of an exemplary building;

FIG. 8 is a schematic representation of a building in which a steam heating system in accordance with one or more embodiments of the invention is installed, illustrating an embodiment of how various elements of the system may communicate; and,

FIG. 9 is a flow chart illustrating a method of operation of the invention.

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

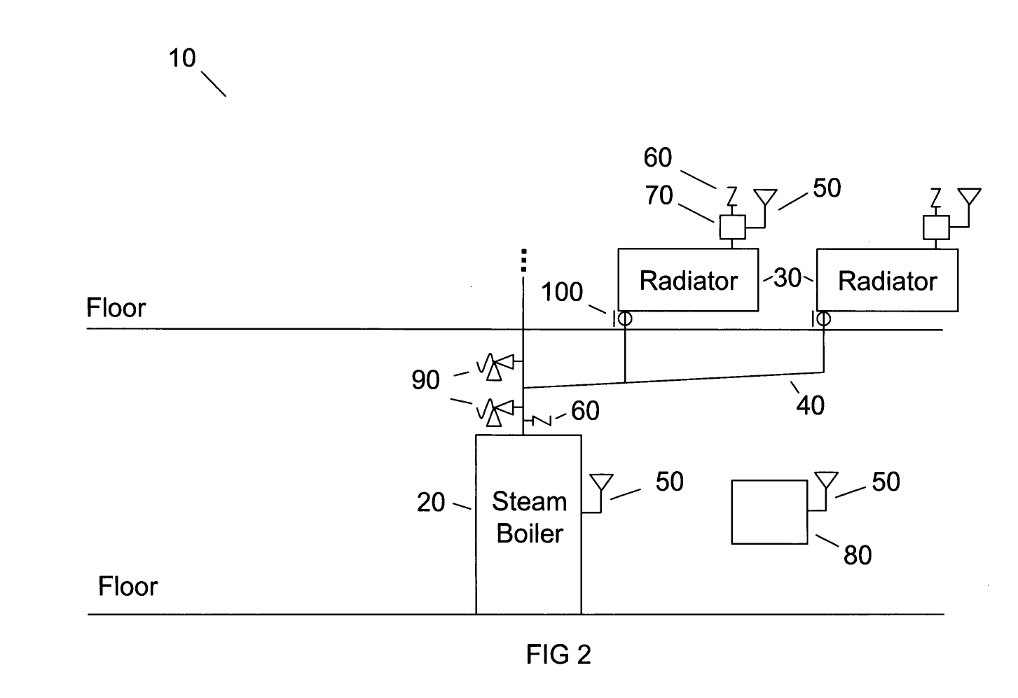

Referring to the drawings in detail wherein like reference numerals identify like elements throughout the various figures, there is illustrated in FIGS. 2-8 steam heating systems and methods for controlling the same according to the invention. These systems may be employed in all types of buildings such as large tenement buildings, factories, single family houses and virtually any other structure that requires heat. The principles and operations of the invention may be better understood with reference to the drawings and the accompanying description.

In a preferred embodiment as illustrated in FIG. 2, the system 10 includes at least one boiler 20, at least one radiator 30 connected to the boiler 20 via pipes 40 and a controller 80. Radiator 30 includes a manual valve 100 for selectively connecting/disconnecting radiator 30 from the system 10. Radiator 30 also includes an air vent 60 (also referred to as a steam release vent) and an air vent control 70.

Air vent control 70 may include a latching solenoid, a low voltage DC motor, a stepper motor, a servo motor or any other device, which can open and close the passage to air vent 60 without requiring constant application of electric current. The air vent control 70 is preferably powered by one or more batteries (not shown), but may alternatively or also be powered by solar panels (not shown) and/or thermoelectric cells (also not shown). While it is also within the scope of the invention that the air vent control 70 receives power by plugging into a standard electrical outlet, this is not preferred as radiators 30 are often not located proximate such an outlet. Air vent control 70 includes at least one radio frequency (RF) transceiver 50 for communicating with a central control 80. Those skilled in the art will recognize that the air vent control 70, and any other device that employs a transceiver, may include separate transmitter(s) and receiver(s) instead of, or in addition to, the transceiver 50 and still fall within the scope of the invention. Air vent control 70 may also include one or more thermometers for determining the temperature of the room and/or the outside air and/or the radiator 30. As illustrated in FIG. 2, air vent control 70 is preferably located in series between radiator 30 and air vent 60. However, those skilled in the art will recognize that air vent control 70 could be located at a point in the system between radiator 30 and steam boiler 20 and still fall within the scope of the present invention. Additionally, those skilled in the art will recognize that, while not preferred, vent control 70 could be employed to replace manual valve 100, thus removing the need to manually open and close radiators 30 at the beginning and end of the heating season.

Air vent control 70 also includes circuitry designed to be aware of the state of the passage to the air vent 60 (open or closed), to change the state of the passage, to receive input from the one or more thermometers, and to transmit any or all of this information to central control 80. Depending on the design choices made, the circuitry may also be required to convert some or all of the information from analog to digital and/or from digital to analog. The circuitry may include an application specific integrated circuit (ASIC), a reduced instruction set computer (RISC), a digital signal processor (DSP) or any other processing circuitry that can be configured to perform the above functions. Preferably, but not required, the circuitry will require relatively low power for operation.

System 10 also includes a central control 80. Central control 80 may be a computer running control software or it can be any other suitable processing device which can be used to schedule and or control the various air vent controls 70. Central control 80 also includes at least one RF transceiver 50 for communicating with air vent controls 70. Central control 80 may also be configured to communicate with and control boiler 20. Central control 80 may be hard wired to or may communicate wirelessly with boiler 20. If central control 80 communicates wirelessly with boiler 20 then boiler 20 will also require a transceiver 50 and a relay 55 for receiving and carrying out instruction from central control 80 to turn the boiler on/off. It will also need to be able to wirelessly transmit boiler status information (e.g. boiler pressure, and/or length of time boiler has been on, etc.) to central control 80.

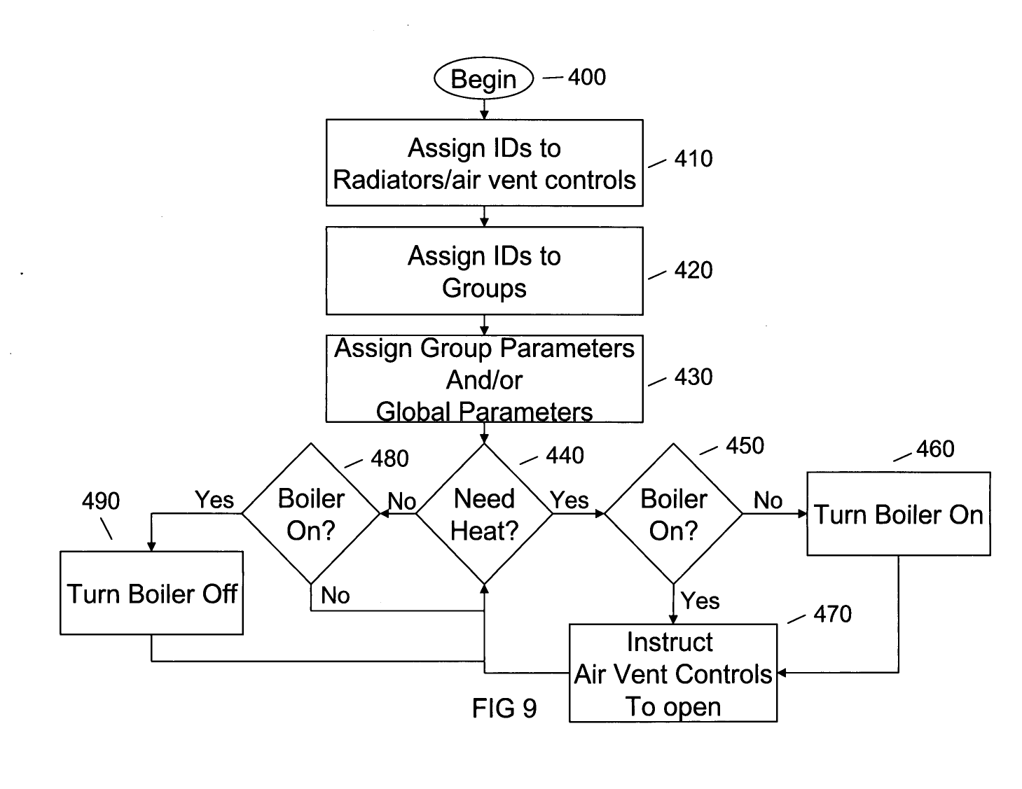

When no heat is needed in any of the zones (440 of FIG. 9) central control 80 will send an instruction to turn off the boiler 20 (490 of FIG. 9). It is also considered within the scope of the invention that the central control 80 could, rather than allowing the boiler to completely cool, instruct the boiler, by sending alternating on and off commands, to maintain the boiler pressure within a predetermined range to speed up the reaction time to a call for heat. It is also considered within the scope of the invention to employ one or modulating boilers in which case central control 80 may send instructions to the boiler to turn completely on or off, send alternating on and off commands, send instructions to raise or lower rate of the gas flow, thus lowering or raising the temperature of the boiler or any combination of the above. When enough radiators require heat (for example if 3 out of 4 radiators in a particular zone register a room temperature below a desired temperature, etc.) central control 80 can either turn on the boiler 20 directly or send a message to boiler 20 to turn on (depending on the design choice of the system) (440-460 of FIG. 9). Conversely, when a predetermined number of zones (e.g. 5 out of 7) are within the desired temperature ranges, central control 80 can either turn off the boiler 20 directly or send a message to boiler 20 to turn off (depending on the design choice of the system) (440, 480, 490 of FIG. 9). Those skilled in the art will recognize that these are merely non-limiting examples. The decisions when to turn the boiler on and/or off are strictly design choices and are not considered limitations on the invention.

Air vent control 70 and central control 80 may be designed to operate with existing systems and/or they could be designed to operate on newly installed systems. In this regard, a conventional radiator includes a threaded aperture designed to receive a threaded stem of an air vent 60. Thus, air vent control 70 may be designed with a threaded stem that is compatible with (capable of mating with) existing radiators. Additionally, air vent control 70 may be designed with a threaded aperture for receiving a conventional air vent 60. While not required, it is considered within the scope of the invention that vent control 70 may include an air vent 60 incorporated therein thus eliminating the need for a separate air vent. Alternatively, air vent control 70 may receive temperature readings from a thermometer 72 attached to the radiator 30 and automatically close when the radiator 30 reaches a predetermined temperature. If the entire system 10 is new, or if one or more radiators 60 are new, the air vent control 70 and the radiator 30 may be configured in any suitable fashion to be mated together or may be made as a single unit and still fall within the scope of the invention.

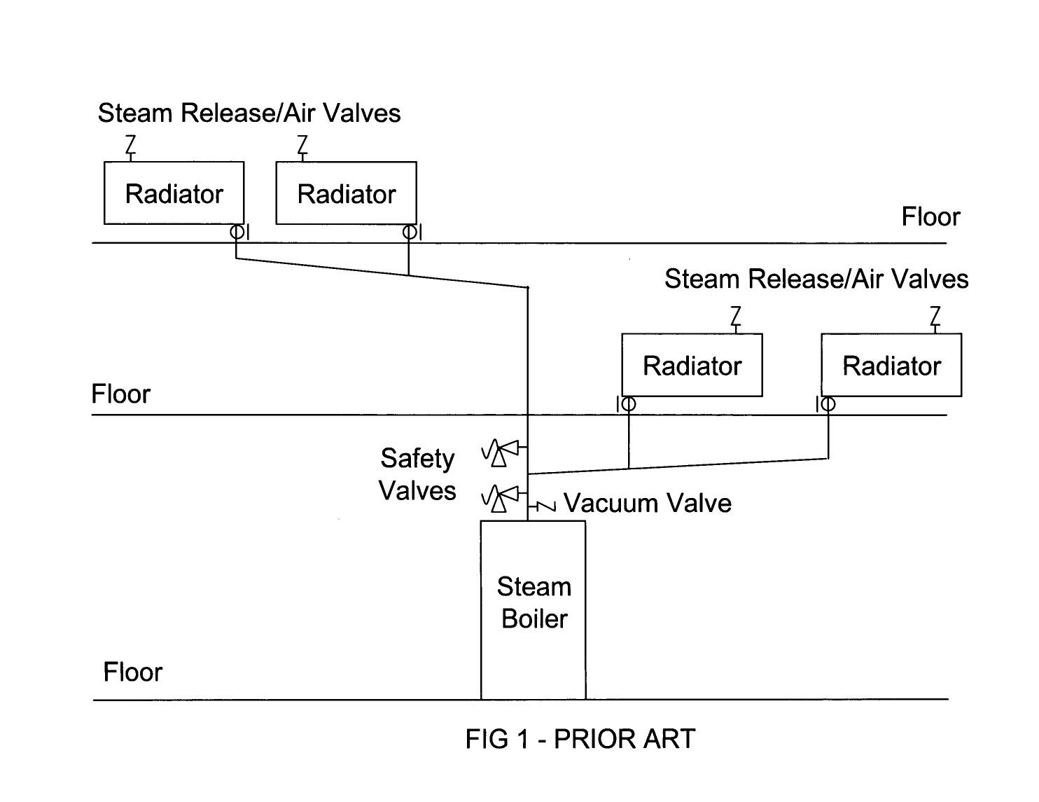

When the system 10 of FIG. 1 is in operation (illustrated in FIG. 9), each air vent control 70 is assigned an identification (ID) for communicating with central control 80 (410). The ID for an air vent control 70 need not be unique; the same ID may be assigned to multiple air vent controls 70. Providing multiple air vent controls 70 with a common ID provides a simple way to create heating zones and minimizes the number of transmissions from central control 80 thus reducing power requirements of the system 10 and potential interference between transmissions. All radiators 30 having a common ID will turn on or off based on a common signal from the central control 80 and central control 80 can make determinations based on information received from a particular zone rather than from an individual air vent control 70. In this configuration central control 80 aggregates all information received from a particular zone rather than analyzing and making determinations based solely on information received from a particular radiator 30. It then makes determinations based on the aggregate information. Alternatively, each air vent control 70 may be provided a unique ID. A zone is then defined by one or more IDs being included in a group and stored at central control 80 (420). IDs in a group can be consecutive but are not required to be. All air vent controls 70 in a common group receive common instructions (430). Another possibility is that each air vent control 70 can be assigned multiple IDs (e.g., a unique ID and a common or zone ID). A multiple ID configuration provides the opportunity for more robust communication protocols. For example, an air vent control 70 with a unique ID and a zone ID could be configured to transmit only the unique ID when sending communications to central control 80. Central control 80 could then compare the unique ID with a list or database or utilize some other conventional way to keep track of elements in a group, to determine the zone associated with the unique ID. However, central control 80 would only need to transmit a zone ID to communicate instructions to the various air vent controls 70 in a particular zone. If central control 80 needs to communicate with a specific air vent control 70 (e.g. for trouble shooting, etc.), then it could transmit the unique ID of that air vent control 70 with, or without the zone ID (depending upon the design of the system). Alternatively, one or both air vent control 70 and central control 80 could communicate both IDs for every communication.

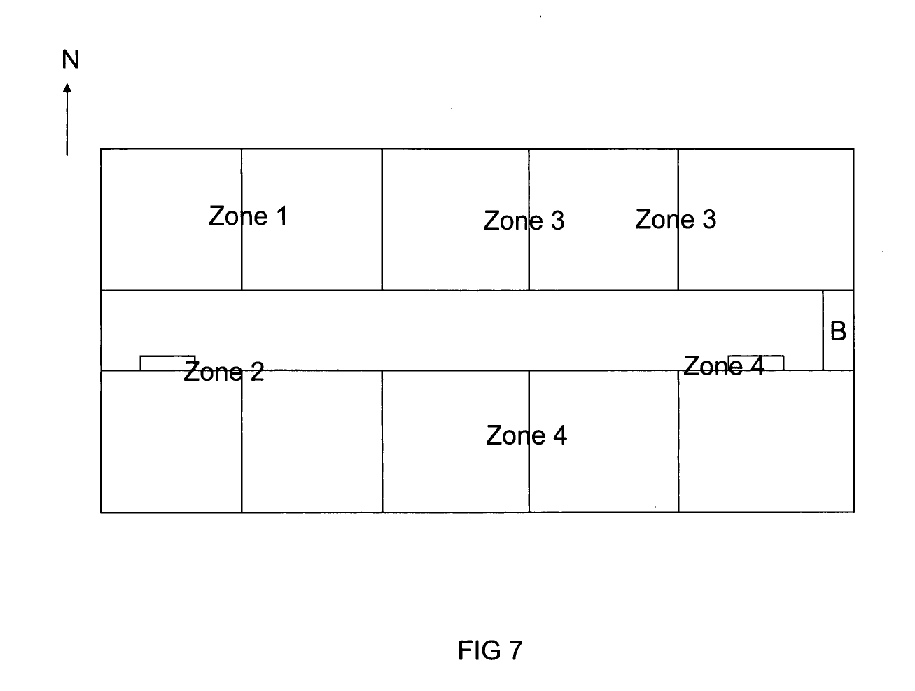

By way of a non-limiting example (illustrated in FIG. 7), assume that a rectangular school building with 10 classrooms (5 on the south side and 5 on the north side) separated by a hallway running east to west. The school originally employs a conventional steam heating system. The boiler is located in the basement at the east end of the building, each classroom has a radiator and the hallway has 2 radiators (1 on the west side of the building and 1 on the east side). It is decided to upgrade the system to the system 10 of the preferred embodiment of the invention. Thus, the air vents 60 are removed (unscrewed) from each radiator and replaced with air vent controls 70. Air vent controls 70 are either assigned an ID during manufacture or they are assigned an ID when they are installed (410 of FIG. 9). This can be performed using dip switches or digitally depending on the system (it can also be hard wired but that removes certain flexibility from the system). The existing air vents are then attached (screwed into) the air vent controls 70. Central control 80 is electrically connected to the boiler 20 such that it can turn the boiler 20 on or off. The circuitry for this type of connection (remotely turning an object on/off using elements such as a relay switch, etc.) is well known and thus will not be described further herein. Once the system is installed and assuming that the system employs a unique ID for each air vent control, the manager of the system can now group the various radiators 30 into zones (420 of FIG. 9). This can be done either using analog switches at central control 80 (for a simple inexpensive system) or digitally using an input device such as a keyboard, mouse, touch screen or some other input device and a graphical user interface (GUI) at central control 80. For purposes of this example we shall assume a digital setup. Once the zones are set, the variables for each zone may be determined (430 of FIG. 9). Those skilled in the art will recognize that the zone variables may be set prior to determining which air vent controls 70 belong to which zone without departing from the scope of the invention. For purposes of this example we shall assume that the school is separated into 4 zones. Zone 1 includes the 2 classrooms in the northwest corner of the building as those are typically the coldest in the morning (farthest from the boiler and no sunlight until the afternoon, if at all). Zone 2 includes the 2 classrooms in the southwest corner and the west side of the hallway. Zone 3 includes the 3 remaining classrooms on the north side of the building and zone 4 includes the 3 remaining classrooms on the south side of the building along with the east side of the hallway. The system is then configured based on the sanitation engineer's knowledge of the building. Zone 1 is set to turn on from 5 am-5 pm unless the zone temperature rises above 73 degrees Fahrenheit, and to turn off for the rest of the day unless the zone temperature falls below 65 degrees Fahrenheit. Zone 2 is set to turn on from 5:30 am-3 pm unless the zone temperature rises above 73 degrees Fahrenheit, and to turn off for the rest of the day unless the zone temperature falls below 65 degrees Fahrenheit. Zone 3 is set to turn on from 6 am-5 pm unless the zone temperature rises above 73 degrees Fahrenheit, and to turn off for the rest of the day unless the zone temperature falls below 65 degrees Fahrenheit. Zone 4 is set to turn on from 6:30 am-noon unless the zone temperature rises above 73 degrees Fahrenheit, and to turn off for the rest of the day unless the zone temperature falls below 65 degrees Fahrenheit.

At various offset intervals, to prevent interference between transmissions, the various air vent controls 70 communicate with central control to provide information such as the state of the air vent control 70 (open/closed) and the temperature in the room. Central control 80 then determines the average temperature for all rooms in a particular zone and determines whether or not the radiators 30 in that zone need to be turned on or off (440 of FIG. 9). If the radiators need to be turned on/off then central control sends a message to that zone to change the state of the air vent control 70 (470 of FIG. 9). With regard to turning the radiator on or off the description may interchangeably refer to turning the radiator on or off or turning the air vent control on or off. This is simply because the end result is the same, heat is provided. Those skilled in the art will recognize that using the average temperature is merely a design choice and some alternate choice could be employed such as the mean, or median temperature, etc. Additionally, central control 80 could be configured to determine if one radiator 30 in a particular zone is drastically out of synch with the other radiators 30 in that zone (e.g., all radiators but one are reading room temperature between 68 and 70 degrees but one radiator is reading 60 degrees). In that instance, central control 80 may be configured to signal the anomalous radiator 30 to turn on (assuming that the boiler 20 is on). In addition to the above settings, the system 10 may be set with global parameters (430 of FIG. 9). For example, since the building in this example is a school, all zones may be set to only operate from Monday to Friday. During weekends and holidays they may all default to off but be set to turn on if the outside temperature falls below 32 degrees and at least 3 room temperatures fall below 40 degrees. Those skilled in the art will recognize that these are merely design choices. Additionally, if the building is in New York, it could be set to only operate from October 15-May 15 (the typical heating season for New York). At any time, any or all of these settings, individual zone, and/or global, may be changed to coincide what works best with the school. Zones can be added or deleted and existing zones can be changed to include different radiators 30. Additionally, zones can be provided with a priority ranking. For example, if it is known that the youngest children are in zone 1 then zone 1 may get the highest priority for heat when the system turns on. If it is known that zone 3 is only used for storage, then that zone could get the lowest priority. Again, these are merely intended as non-limiting examples and priority could be set in any number of ways and still fall within the scope of the invention. Another example of how to determine priority could be based on the temperature setting of a zone. The highest temperature could get the highest priority and the lowest temperature the lowest priority.

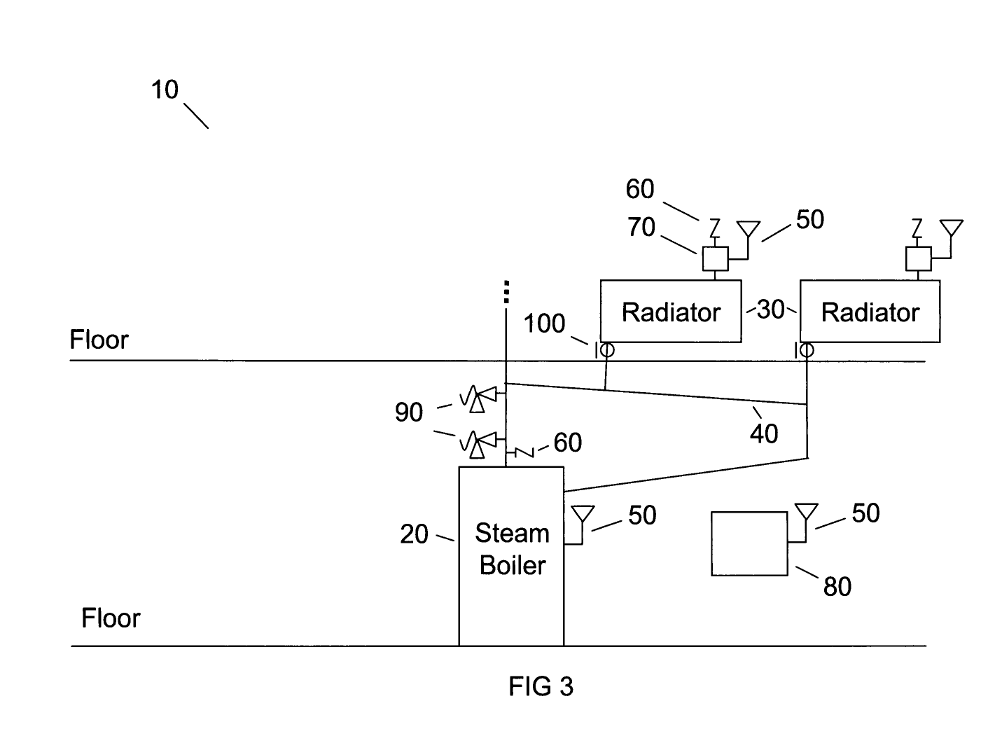

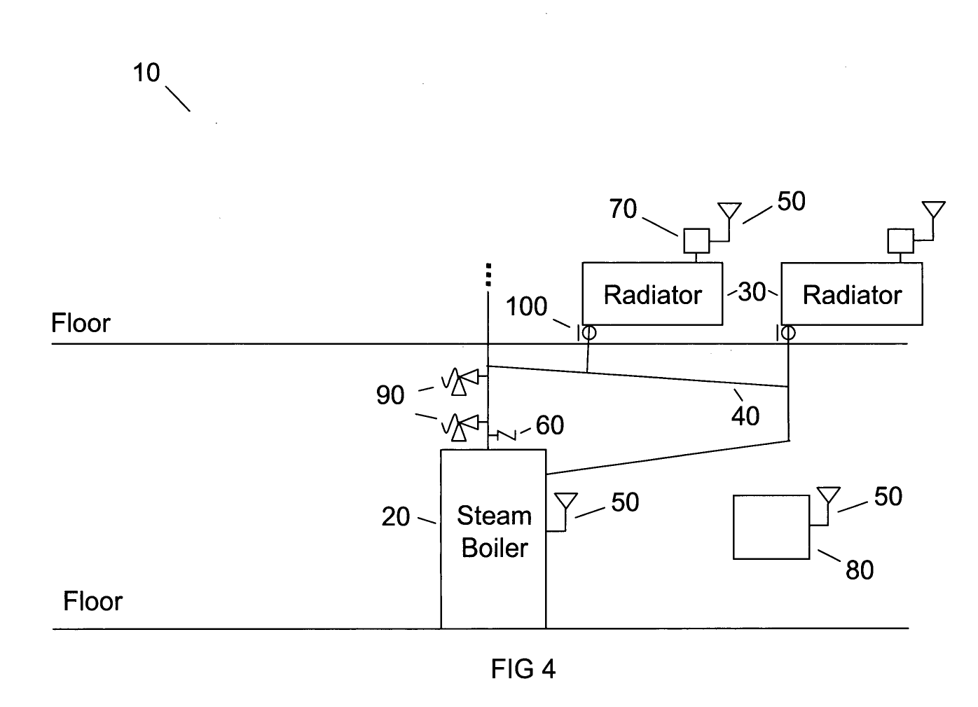

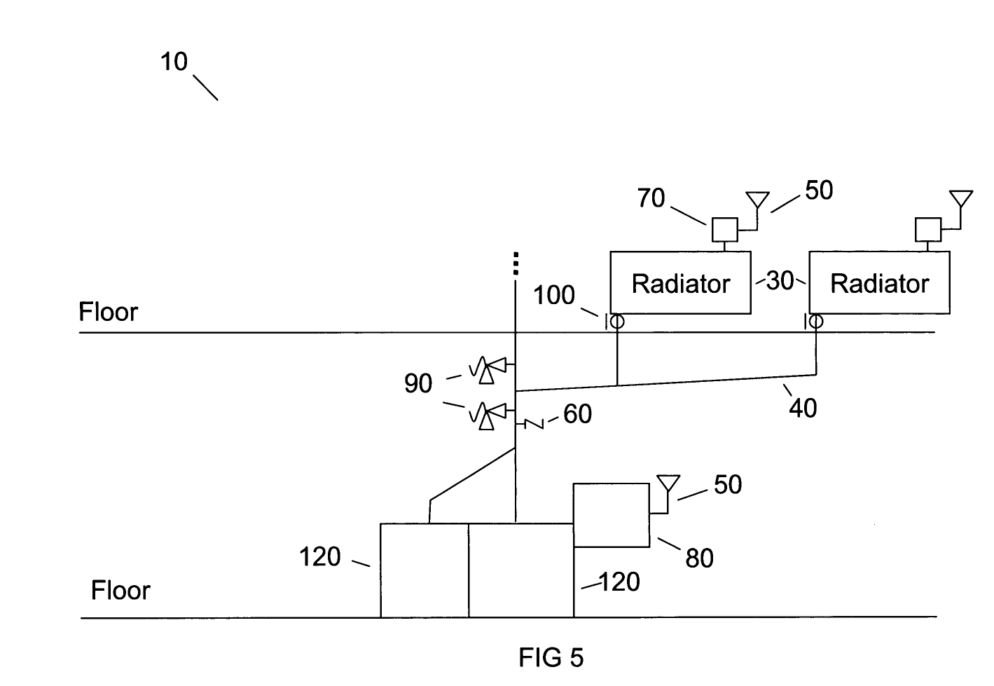

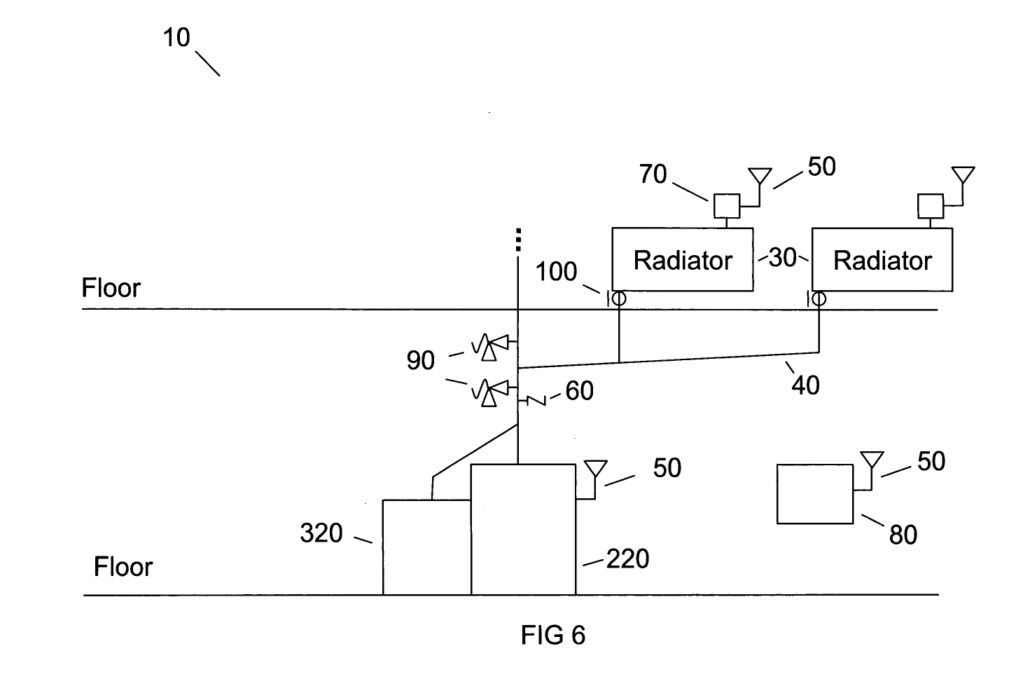

Having thus described preferred embodiments of the invention, advantages can be appreciated. Variations from the described embodiments as illustrated in FIGS. 4-8 exist without departing from the scope of the invention. Embodiments such as those illustrated in FIGS. 5 and 6 are similar to those illustrated in FIGS. 2 and 3. The main difference is that the embodiments of FIGS. 5 and 6 employ multiple boilers 120, 220, 320 rather than a single boiler 20 to operate the system. In FIG. 5, the boilers 120 are the same size but in FIG. 6 one boiler 320 is smaller than the other 220. These differences from the previously described embodiments allow the system to operate more efficiently. For example, in the system of FIG. 5, when the entire system is on, both boilers 120 may be operating. When fewer than all of the zones require heat, one of the boilers 120 can be turned off to save energy. In the system of FIG. 6, when the entire system is on, either both boilers 220, 320 may be operating or just the larger boiler 220 may be operating depending on the requirements of the system 10. When fewer than all of the zones require heat, one of the boilers can be turned off, or if just the larger boiler 220 was on, it can be turned off and the smaller boiler 320 turned on to save energy.

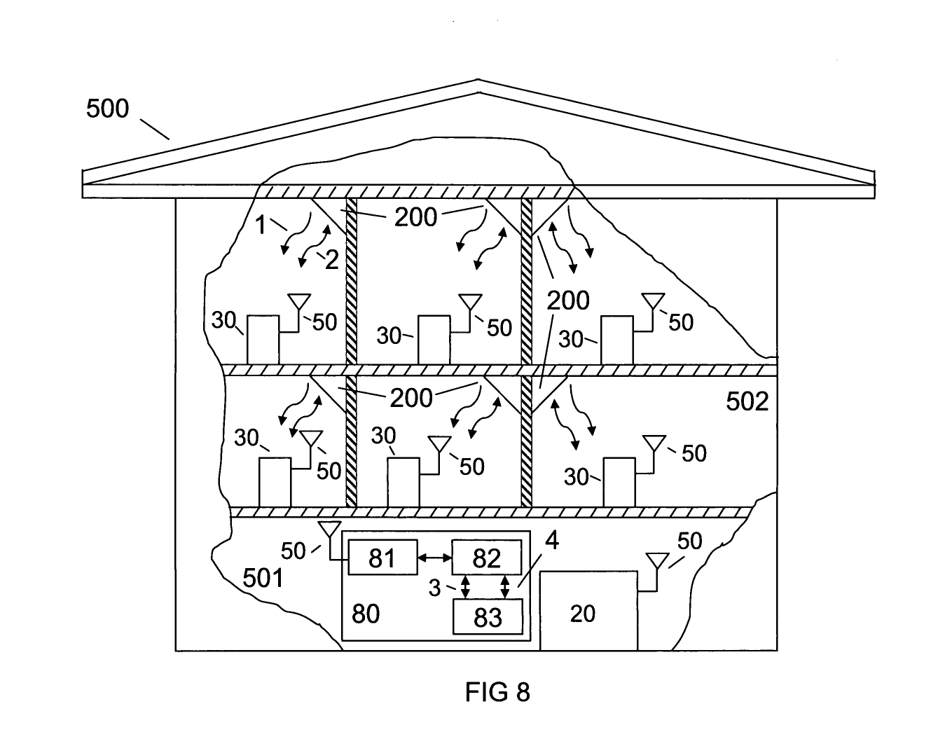

An alternate embodiment is illustrated in FIG. 8 and provides for longer life of the power source for the air vent controllers 70. The overall operation of the system illustrated in FIG. 8 operates generally in the same manner as described above. The only difference is how the various elements of the system communicate. As such, for ease of illustration and explanation the pipes, air vent controls and air vents have been left out of the figure. However, those skilled in the art will recognize that they are still part of the system. The system illustrated in FIG. 8 employs both infrared (IR) 1 and radio frequency (RF) 2 communications. Since IR receivers require less power than RF receivers and RF transmitters require less power than IR transmitters, the air vent controls are equipped with IR receivers and RF transmitters.

In FIG. 8, a building 500 is illustrated having multiple rooms, each with a radiator 30. The building 500 also includes a basement 501 with a boiler 20 and central control 80. Central control 80 may include receiver 81, decoder 82 and processor 83. Also included are room units 200. Room units 200 include IR and RF transmitters and RF receivers. These units may be mounted from the ceiling or on a wall of the room and may be plugged into an alternating current (AC) outlet. Alternatively, these units may be battery powered. However, these units may employ larger more powerful batteries than the air vent controls. When a room unit is located at a low level on the wall or behind an obstruction, IR communication will still be possible by virtue of reflections from the ceiling and/or floor and/or walls of the room.

A room unit 200 can be designed to either communicate with a single air vent control via IR 1 and the central command via RF 2 communications or it can be designed to communicate with multiple or all air vent controls in a room if there are multiple radiators in a particular room. As with the above described embodiments, communications may be based on an ID of one or more units and/or a group/zone ID. Room units 200 do not need to be very complex. Their purpose is essentially to receive RF communications 2 and retransmit those received communications either in IR 1 if the communication is intended for an air vent control or in RF 2 if the communication is intended for the central control. Preferably, all IR communications 1 will be at a frequency that avoids interference from devices such as fluorescent lamps, etc.

When an air vent control communicates with central control it transmits an RF signal 2. This signal may be a burst communication or it may be a standard communication. While burst communications will save energy it is not a requirement. Since the RF communication 2 only needs to reach the room unit 200 the signal strength need not be very high. The room unit 200 detects the RF communication 2 and retransmits the communication to the central control 80 (with a stronger signal if necessary). The communication from the air vent control to the room unit 200 and the RF communications 2 between the room unit 200 and the central control 80 may be transmitted at the same frequency or they may be transmitted at different frequencies to avoid interference. Additionally, the RF frequencies can be designated particularly for a facility 500 and interference from other RF sources minimized with appropriate isolation techniques. A room unit 200 may be assigned its own ID for communications or it may share the same ID as the air vent controls with which it communicates.

In addition to the above features and functions, the invention may include additional energy saving features. For example, the system may include a pressure gauge on or near the boiler which can be employed to determine the minimum steam pressure of the boiler to reach a radiator and the minimum pressure required to reach all radiators so that they are all sufficiently heated for their settings. For example, all of the radiators can be turned off except one (e.g. the farthest from the boiler) and the boiler turned on. When that radiator reaches a sufficient temperature to heat the room to the desired temperature, the pressure at the boiler can be determined from the pressure gauge and stored for future use. Additionally, the amount of time it took for the radiator to reach the temperature can be stored and used for further refining the system. This process can be performed for individual radiators or groups of radiators. The system can then use this information to determine which boiler to employ (in a system with multiple boilers) and/or when the boiler can be turned off after supplying heat to a particular radiator or zone. The system may employ a thermometer in an outdoor location which communicates directly or indirectly with central control 80. Central control 80 can use this information to determine whether or not heat is required, regardless of whether or not the various zones are calling for heat. Various radiators may be flagged as being close to an exit door and thus receive special treatment. The furthest radiator from the boiler may be flagged for priority purposes, etc. Any or all of this information may be employed by central control to refine the system. The more information central control is provided the more robust the system can be and the more options it can have for programming. In addition to being placed on the radiators, air vent controls may be placed on various pipes throughout the system. This could be used to close off entire portions of the system thus enabling the steam to reach other sections of the system faster with less pressure required of the boiler.

An optional feature of the system is a choice between a more economical setting and a more luxurious setting. The more economical setting could require feedback from the radiators less frequently and/or it could react to temperature changes slower. For example, if the desired room temperature was 70 degrees, the more economical setting could wait until the temperature of the room reached 65 degrees before providing heat whereas under a luxury setting the system could be designed to provide heat if the temperature in the room dropped to 69 degrees. Those skilled in the art will recognize that this setting could be a sliding scale, a binary decision or fixed degrees such as 100% economy 50% economy 50% luxury and 100% luxury. 100% economy could be a 5 degree drop, 50% could be a 2 degree drop and 100% luxury could be a 1 degree drop. These are merely non-limiting examples.

When the system first turns on after being shut down for any substantial amount of time (e.g. the boiler and the various radiators are all cold) central control polls each air vent control 70 to determine the status of the radiator and room. It also determines the status of the boiler to make sure that it is cold and has been off for a sufficient amount of time that is determined to be safe. It may also determine the outside temperature. If the outside temperature is above the temperature set for heat then central control may leave the system off and wait for the outside temperature to drop before polling the air vent controls. Once the outside temperature drops, central control will begin polling (440 of FIG. 9). If at this time any or enough of the zones require heat and it is determined that it is safe to turn the boiler on (450 of FIG. 9) central control will transmit a signal to the boiler to turn on (460 of FIG. 9). If after the boiler has been turned on for a set period of time (e.g. 30 minutes) and no radiators are receiving heat, central control may be configured to send a signal to the boiler to turn off. The system may then turn off and provide an error signal or it may attempt to determine the problem depending on the design choice made for the system. Assuming the system is functioning correctly, there may be a priority order for the system to provide heat. If so, then central control will instruct the highest priority zone to open the air vents and begin receiving heat (470 of FIG. 9). Once the highest priority zone radiators reach a certain temperature central control may instruct the zone with the next highest priority to open the air vents and so on until all zones have reached the desired temperatures.

Thus it is seen that steam heat systems and methods for controlling various aspects of the systems are provided. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the invention as defined by the claims. By way of non-exclusive example, air vent control may be provided with sufficient programming to automatically close, without the need for a signal from central control when the temperature of the radiator reaches or exceeds a predetermined temperature. By way of another non-exclusive example, in large structures, the system may employ one or more repeater units for receiving and retransmitting communications between central control and the various air vent controllers. The repeaters may be configured to receive and retransmit using the same transmission format (e.g. RF) or it may be configured to receive in one format and retransmit in another format, similar to the room units described herein. With still another non-exclusive example, the system may employ other forms of transmissions such as frequency modulations (FM), etc. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A system for providing and regulating steam heat in a building which has a plurality of rooms, a boiler and a plurality of radiators in the plurality of rooms, each radiator being connected to the boiler via a network of pipes, the system comprising:
a central processor configured to monitor and adjust said system;
said central processor including a central processor transceiver;
a plurality of air vent controllers each including an air vent controller transceiver for wireless communication with said central processor and each being adapted to be attachable to a respective radiator; said plurality of air vent controllers having an open state in which air may flow through the air vent controller and a closed state in which air is prevented from flowing through said air vent controllers, said air vent controllers being separated into a plurality of groups;
a plurality of room thermometers respectively coupled to said plurality of air vent controllers configured to determine a respective room temperature;
each of said air vent controllers being configured to communicate the respective room temperature and the state of the air vent controller to said central processor via said air vent controller transceiver;
said central processor being configured to, at least in part in response to said communication from said air vent controllers, determine that a group of said air vent controllers needs to be placed in the open state and to send an instruction to that group of air vent controllers to change to the open state;
said group of air vent controllers being configured to, in response to said instruction from said central processor, change to the open state.

2. The system according to claim 1 further comprising:
a boiler control including a transceiver for wireless communication with said central processor; said boiler control being adapted to connect to and control said boiler;
said boiler control also configured to monitor said boiler and communicate information about said boiler to said central processor;
said central processor being further configured to, in response to said determination that a group of said air vent controllers needs to be placed in the open state determine a state of said boiler and if the state of said boiler is off then send an instruction to said boiler control to change said boiler state to on.

3. The system according to claim 2, wherein said boiler control further comprises a pressure monitor configured to monitor a pressure within said boiler, said boiler control further configured to provide the boiler pressure to said central processor.

4. The system according to claim 3 wherein said central processor is configured to determine a minimum boiler pressure required to heat said radiators.

5. The system according to claim 1 wherein at least one air vent control includes a radiator thermometer configured to determine a temperature of a respective radiator and wherein said at least one air vent control is configured to change from an open state to a closed state when said radiator temperature reaches a predetermined temperature.

6. The system according to claim 1 further comprising:
an air vent having an open and closed state and a strip configured to change said air vent from said open state to said closed state upon steam impacting said strip;
wherein at least one of said plurality of air vent controllers has an aperture configured to receive said air vent, such that when said air vent controller is in the open state, air from the radiator flows through said air vent controller to said air vent and when said air vent controller is in the closed state air from the radiator is prevented from flowing to the air vent.

7. The system according to claim 1 wherein at least one of said plurality of air vent controllers further comprises a direct current (DC) power supply for supplying power to said air vent controller.

8. The system according to claim 7 wherein said air vent controller comprises a latching solenoid.

9. The system according to claim 1 wherein said central processor comprises a processor, a memory coupled to said processor, and an input device and a graphical user interface (GUI) both electrically coupled to said processor.

10. The system according to claim 1 further comprising an outdoor temperature unit;
said outdoor temperature unit including a thermometer and a transmitter configured to transmit a temperature from said thermometer to said central processor.

11. The system according to claim 1 further comprising at least one room unit said room unit comprising an infra-red (IR) transmitter, a radio frequency (RF) transmitter and an RF receiver;
at least one of said air vent controllers having an air vent controller transceiver that comprises an IR receiver and an RF transmitter;
said central processor transceiver comprises an RF transceiver;
said central processor being configured to communicate with said at least one air vent controller via said room unit;
said room unit being configured to receive a central processor originating RF transmission from said central processor convert the central processor originating RF transmission into an IR transmission and retransmit said central processor originating transmission to said at least one air vent controller via said IR transmitter;
said at least one air vent controller being configured to communicate with said central processor via said room unit; and,
said room unit being configured to receive a air vent controller originating IR transmission from said at least one air vent controller and convert the air vent controller originating IR transmission into an RF transmission and retransmit said air vent controller originating transmission to said central processor via said RF transmitter.

12. A method of providing steam heat to a building that has a boiler and a plurality of radiators connected to the boiler via a network of pipes, the method comprising:
assigning identifiers to a plurality of radiators;
separating said plurality of radiators into a plurality of groups based on said identifiers;
configuring each of said plurality of radiators within a group to operate on a common set of parameters;
monitoring said parameters at a central processor;
receiving at said central processor, communications from said plurality of radiators in a group and determining from those communications parameters of the group;
determining at said central processor, when said group parameters require said group to provide heat;
determining at said central processor, a state of the boiler;
sending an instruction to turn on from the central processor to the group of radiators, if the state of the boiler is on;
and sending an instruction from the central processor to the boiler to turn on prior to sending said instruction to said group of radiators, if the state of the boiler is off.

13. The method according to claim 12 wherein said common set of parameters are parameters selected from the group consisting of room temperature, radiator temperature, time of day, date, outside temperature and season.

14. The method according to claim 12 further comprising assigning a priority level to each group of radiators and determining at said central processor whether the parameters of a group indicate that the group requires heat in order of said priority level.

15. The method according to claim 12 further comprising determining by said central processor that at least one group of radiators not longer requires heat and sending a message from the central processor to the boiler to turn off the boiler.

16. The method according to claim 12 further comprising:
monitoring by said central processor a boiler pressure for a predetermined amount of time after sending said signal for the boiler to turn on;
determining after said predetermined period of time if at least one of the radiators in the group of radiators which were instructed to turn on has reached a maximum temperature; and sending an instruction from the central processor to the boiler to turn off if no radiator from the group has reached the maximum temperature.

17. A steam heating system comprising:
a plurality of radiators, each having an inlet for steam and an outlet for air;
wherein at least some of said plurality of radiators are assigned an identifier for grouping said at least some of said plurality of radiators into a plurality of groups of radiators;
a source of steam;
conduits connecting said source of steam to said inlets of said at least some of said plurality of radiators such that steam from the source of steam is capable of traveling through the conduits to the inlet of each of the at least some of said plurality of radiators pushing colder air through the inlet and out the outlet of each radiator until the outlets are closed;
each of said at least some of said plurality of radiators includes an air vent controller coupled to the radiator at said outlet; said air vent controller automatically closing said outlet when a temperature of said radiator reaches a predetermined temperature thus preventing air to flow through said radiator;
a central processor located remote from said radiator, configured to wirelessly communicate with the air vent controllers in said groups of radiators, and configured to signal said air vent controllers to open said radiator outlets as a group based on predetermined parameters for the group; and,
a battery electrically coupled to said air vent controller for providing pulses of electrical current to change the air vent controller from open to closed or closed to open and to provide electrical current for communicating with said central processor.

18. The system according to claim 17 wherein said central processor is further configured to signal the source of steam to turn off when no groups of radiators require heat.

19. The system according to claim 17 wherein said central processor is further configured to signal the source of steam to turn on when a group of radiators requires heat.
